(19) United States
(12) Patent Application Publication
(10) Pub. No.: US 2008/0283789 A1
(43) Pub. Date: Nov. 20, 2008

(54) Valve for controlling the flow of fluid

(76) Inventors: Diana Rubio, El Paso, TX (US); Claudia Ramirez, El Paso, TX (US)

Correspondence Address: DELPHI TECHNOLOGIES, INC., M/C 480-410-202, PO BOX 5052, TROY, MI, 48007, US

(21) Appl. No.: 11/803,351

(22) Filed: May 14, 2007

(51) Int. Cl. F16K 1/00

(52) U.S. Cl. 251/324

(57) ABSTRACT

A valve is provided for controlling the flow of fluid through a valve block. The valve block has a fluid inlet port, a fluid outlet port, and a receiving bore for receiving the valve. The receiving bore hydraulically connects the fluid inlet and outlet ports, and has a central axis. The valve comprises a valve seat for placement between the fluid inlet and outlet ports, wherein the valve seat comprises a central axis which coincides with the central axis of the receiving bore, and wherein the valve seat further comprises an upper end overmolded by a valve seat attachment end of a plastic valve housing. The valve also includes a tube which comprises a central axis which coincides with the central axis of the receiving bore, wherein the tube further comprises a lower end overmolded by a tube attachment end of the valve housing.

### TECHNICAL FIELD OF INVENTION

The present invention relates to a valve for controlling the flow of fluid through a valve block, particularly, but not exclusively, a valve for controlling the flow of fluid in the anti-lock brake system of a motor vehicle.

### BACKGROUND OF INVENTION

Many modern motor vehicles use hydraulically actuated anti-lock brake systems for slowing and stopping the vehicle. Anti-lock brake systems are designed to detect when one or more wheels of the motor vehicle are about to encounter a wheel lock up condition. In response to this detected condition, the anti-lock brake system will modulate brake pressure to the wheel or wheels that are going to lock up, thus preventing the wheel or wheels from skidding on the road surface, and allowing for greater control of the vehicle by the driver.

Typical anti-lock brake systems use one or more actuatable valves to control the flow of hydraulic fluid between components of the system such as the master cylinder, individual wheel cylinders, and a pump. An example of such a valve is shown in U.S. Pat. No. 6,431,208 which includes a lower seat body that is secured into a bore formed in the lower end of a central body. A lower tube is also provided which attaches to the upper end of the central body. The lower tube is shown threaded into the central body, but attachment could also be accomplished by welding the two components together. An armature with a plunger is guided axially within the inside diameter of the lower tube. The axial movement of the armature and plunger controls the flow of fluid through the lower seat body.

One shortcoming of the interaction between the lower seat body, central body, and lower tube is the accuracy with which each must be formed in order to allow for correct engagement of the plunger with a valve seat which is formed on the lower seat body. Specifically, the position of the valve seat formed in the lower seat body is dependent upon the forming of the bore in the central body which receives the lower seat body, the forming of the outside diameter of the lower seat body, and the forming of the valve seat itself. Furthermore, the resulting position of the plunger which engages the valve seat is dependent on the internal threads of the central body and external threads of the lower tube which join the two components together. Unless a close tolerance in the formation of each these features is maintained, variation can accumulate and result in poor engagement of the plunger with the valve seat, thus resulting in undesirable performance.

Another shortcoming for the valve disclosed in U.S. Pat. No. 6,431,208 is the high processing costs for joining the lower seat body, central body, and lower tube. The need for close tolerances as previously mentioned inherently increases the cost as compared to less stringent tolerance requirements. Additionally, the processes involved with forming the internal threads of the central body and external threads of the lower tube add cost. Alternatively, cost is also associated with a welding operation if the central body and the lower tube are joined by a welded connection rather than a threaded connection.

The present invention recognizes the above mentioned prior art shortcomings, and provides solutions to one or more of these shortcomings as will be described in more detail in the disclosure that follows.

### SUMMARY OF THE INVENTION

According to a preferred embodiment of the present invention, there is provided a valve for controlling the flow of fluid through a valve block. The valve block has a fluid inlet port, a fluid outlet port, and a receiving bore for receiving the valve. The receiving bore hydraulically connects the fluid inlet and outlet ports, and has a central axis. Furthermore, the valve comprises a valve seat for placement between the fluid inlet and outlet ports, wherein the valve seat comprises a central axis which coincides with the central axis of the receiving bore, and wherein the valve seat further comprises an upper end overmolded by a valve seat attachment end of a plastic valve housing. The valve also includes a tube which comprises a central axis which coincides with the central axis of the receiving bore, wherein the tube further comprises a lower end overmolded by a tube attachment end of the valve housing.

By having the tube and valve seat overmolded by the valve housing, features of the valve seat and tube which affect the engagement of a plunger with the valve seat can be aligned before the valve housing is molded. Specifically, the valve seating surface of the valve seat can be held in proper alignment with the inside diameter of the tube. In this way, only the features which directly interface with the plunger affect the engagement of the plunger with the valve seat upon final assembly of the valve, rather than features unrelated to the engagement, as is shown in the prior art. Furthermore, when the valve housing is formed, the valve seat and tube are simultaneously joined together. This eliminates the need for costly processes associated with joining these components as well as eliminating the need for costly features and tolerances needed to precisely assemble the components for proper engagement of the plunger with the valve seat.

Further features and advantages of the invention will appear more clearly on a reading of the following detailed description of the preferred embodiment of the invention, which is given by way of non-limiting example only and with reference to the accompanying drawings.

### BRIEF DESCRIPTION OF DRAWINGS

This invention will be further described with reference to the accompanying drawings in which:

FIG. 1 is a cross section of a valve and valve block assembly according to an embodiment of the present invention;

FIG. 2 is a cross section of a valve block for receiving a valve of the present invention;

FIG. 3 is a cross section of a valve according to an embodiment of the present invention;

FIG. 4 is a cross section of a valve housing according to an embodiment of the present invention;

FIG. 5 is a cross section of a valve seat according to an embodiment of the present invention; and

FIG. 6 is a cross section of a tube according to an embodiment of the present invention.

### DETAILED DESCRIPTION OF INVENTION

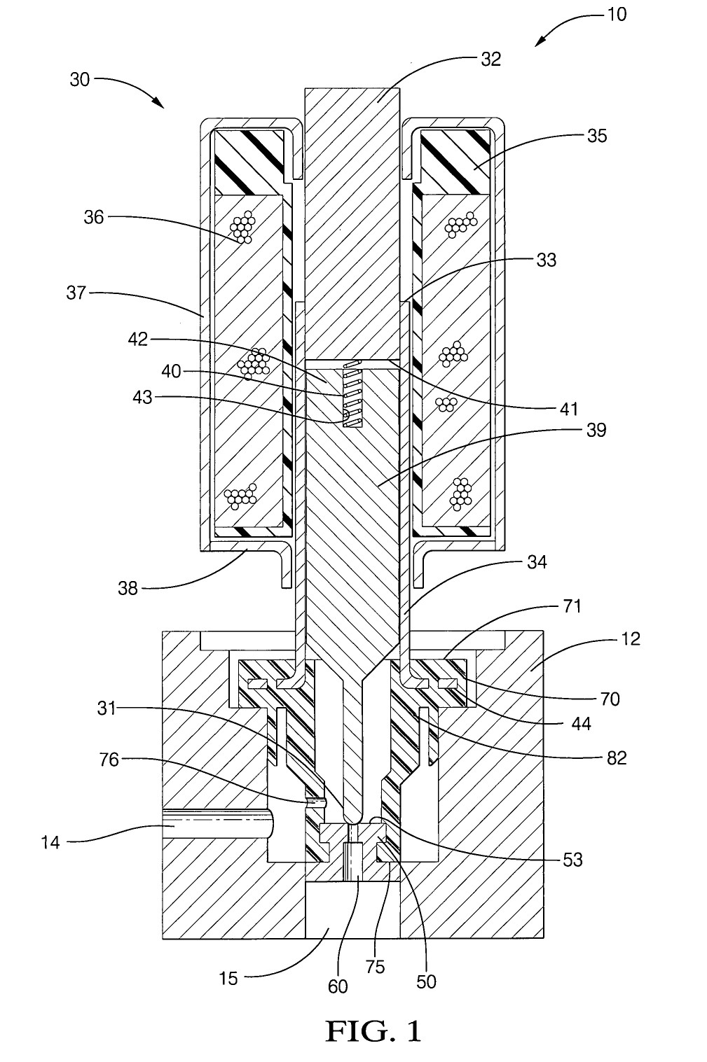

As illustrated in FIGS. 1, 2, and 3, a preferred embodiment of the present invention includes a valve 11 for controlling the flow of fluid through a valve block 12. Valve 11 is inserted into a receiving bore 13 located in the valve block 12, thus forming a valve and valve block assembly 10.

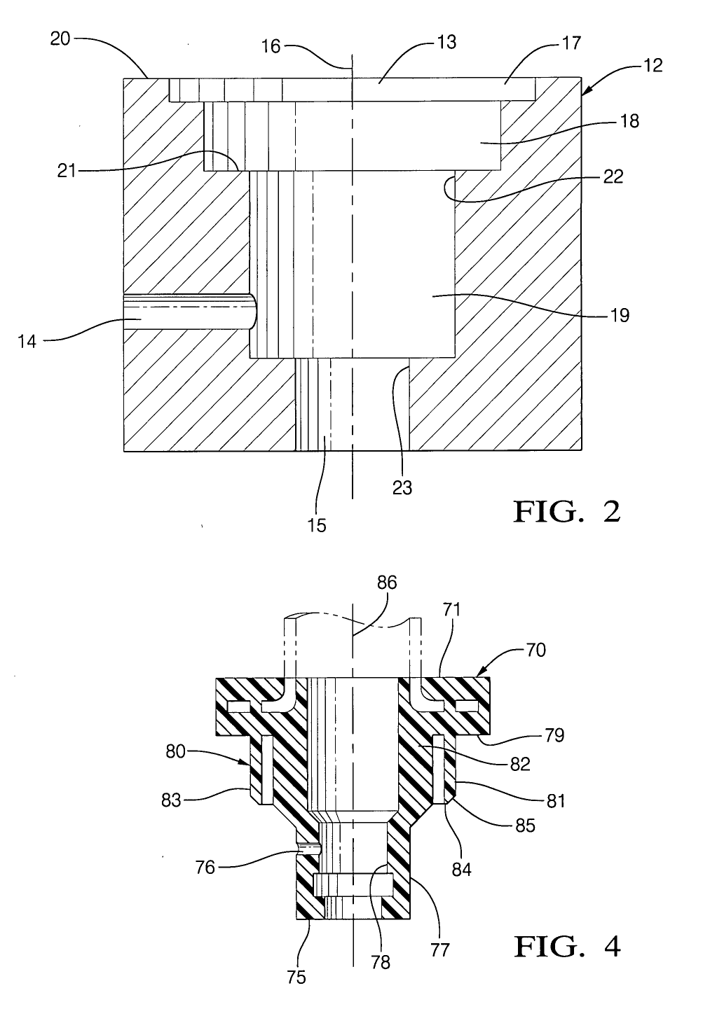

As shown in FIG. 2, the valve block 12 includes a fluid inlet port 14 and a fluid outlet port 15 that are hydraulically connected by the receiving bore 13 which includes a central axis indicated by the center line 16. The receiving bore 13 is made up of a series of coaxial stepped bores, including: a valve retaining bore 17 that is used to retain the valve 11 in the receiving bore 13, a valve locating bore 18 for locating the valve 11 in the receiving bore 13, and a working bore 19 for receiving fluid from the fluid inlet port 14. The valve retaining bore 17 is located adjacent to an outer surface 20 of the valve block 12 which is generally perpendicular to the central axis 16. The valve locating bore 18 is adjacent to and diametrically smaller than the valve retaining bore 17, and includes a valve locating ledge 21 defining the bottom of the valve locating bore 18. The working bore 19 is adjacent to and diametrically smaller than valve locating bore 18, and includes an external sealing surface 22 located at the top of the working bore 19. A bypass sealing surface 23 is located at the top of the fluid outlet port 15 which is adjacent to the working bore 19.

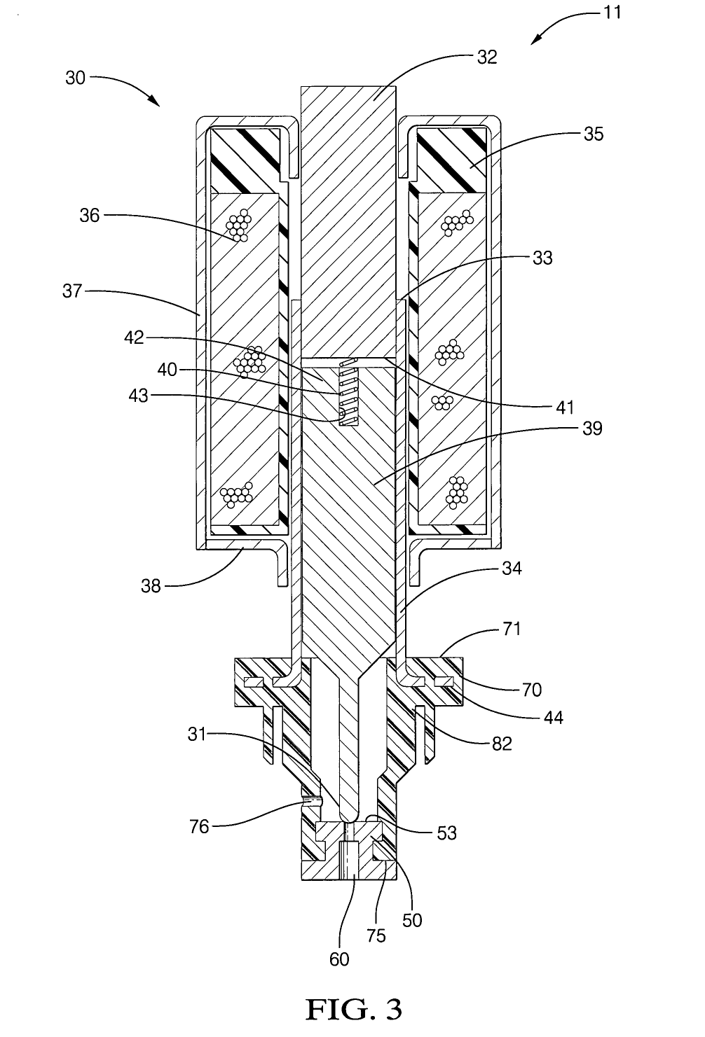

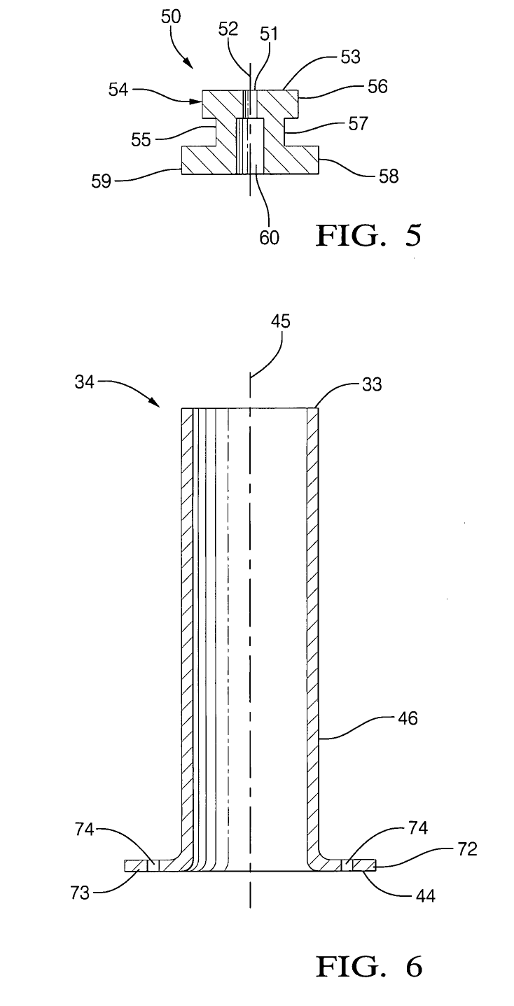

The valve 11 of a preferred embodiment is shown in FIG. 3. The valve 11 includes an actuation member 30 for selectively opening and closing a plunger 31 against a valve seating surface 51 (shown in FIG. 5) of a valve seat 50. The actuation member 30 includes a stator 32 which is preferably made from a ferromagnetic material. The stator 32 is secured to an upper end 33 of a tube 34 by way of the stator 32 being press fit into the upper end 33 of the tube 34. A bobbin 35, for supporting a coil 36, radially surrounds the stator 32 and the tube 34. A sleeve 37 and a sleeve lid 38 are provided to enclose the coil 36 and bobbin 35, thus providing protection from the operating environment. In a close tolerance fit, an armature 39 which is connected with the plunger 31 is received within the tube 34, thereby closely maintaining their coaxial relationship while still allowing the armature 39 to move axially upon a change in actuation state of the actuation member 30. A spring 40 is placed between the stator 32 and the armature 39 in order to urge the plunger 31 to a normally closed position when there is no electrical current supplied to the coil 36. The spring 40 is received in a spring pocket 43 formed in the upper end 42 of the armature 39, and contacts a lower surface 41 of the stator 32.

As shown in FIG. 6, the tube 34 includes a lower end 44 and a central axis as designated by center line 45. The lower end 44 is adapted to be overmolded by a tube attachment end 71 (shown in FIG. 4) of a plastic valve housing 70. Preferably, the lower end 44 includes a locking means 72 for securely connecting the tube 34 to the valve housing 70, thus preventing axial and radial movement between the two components. In a preferred embodiment, the locking means 72 is a flange 73 that extends radially outward from the outside diameter 46 of the tube 34. Optionally, the flange 73 includes one or more through holes 74 which are generally parallel to the central axis 45. The through holes 74 further aid in locking the tube 34 to the valve housing 70 by preventing rotation of the two components relative to each other. Although the locking means 72 has herein been disclosed as the flange 73, the locking means 72 could take many forms such as individual tabs or projections extending radially outward from the outside diameter 46 of the tube 34, holes which are generally perpendicular to the central axis 45 wherein the holes extend through the tube 34, or a knurled finish on a surface of the tube 34.

As shown in FIG. 5, the valve seat 50 has a central through bore 60 which hydraulically connects an upper end 53 of the valve seat 50 with the fluid outlet port 15 (shown in FIG. 1) in order to allow fluid to pass through the valve seat 50 when the plunger 31 is lifted from the valve seating surface 51. Furthermore, the central through bore 60 is coaxial to a central axis as designated by center line 52 of the valve seat 50. The upper end 53 is adapted to be overmolded by a valve seat attachment end 75 (shown in FIG. 4) of the valve housing 70. Preferably, the upper end 53 includes a locking means 54 for securely connecting the valve seat 50 to the valve housing 70, thus preventing axial and radial movement between the two components. The locking means 54 is preferably an undercut 55 which extends radially inward from a first diameter 56 of the valve seat 50, forming a second diameter 57 which is smaller than the first diameter 56. The first diameter 56 is adjacent to the upper end 53 while the second diameter 57 is located below the first diameter 56. The locking means 54 has herein been disclosed as the undercut 55, however, the locking means 54 could take many forms such as individual tabs or projections extending radially outward from the valve seat 50, or a knurled finish on a surface of the valve seat 50.

The valve seat 50 also includes a sealing means 58 for sealing against the bypass sealing surface 23 (shown in FIG. 2) of the valve block 12. The sealing means 58 prevents fluid from leaking into the fluid outlet port 15 when the plunger 31 is seated against the valve seating surface 51. As disclosed, the sealing means 58 is a lower and radially outermost annular edge 59 of the valve seat 50 located below the locking means 54, and is sized to provide an interference fit with the bypass sealing surface 23 of the valve block 12 when the valve 11 is inserted in the receiving bore 13. Furthermore, the annular edge 59 is provided with a surface finish suitable to achieve a fluid tight interface with the bypass sealing surface 23. The sealing means 58 has herein been disclosed as the annular edge 59; however, the sealing means 58 could take many forms such as an O-ring or lip seal.

The valve housing 70 is formed in an overmolding operation by holding the tube 34 at a predetermined distance from the valve seat 50 such that the central axis 45 of the tube 34 coincides with the central axis 52 of the valve seat 50. Furthermore, the tube 34 is oriented such that the lower end 44 of the tube 34 faces the upper end 53 of the valve seat 50. All parts are held so as to orientate them, axially and radially, in the proper location to interfit with corresponding surfaces in the receiving bore 13 as described above. A mold cavity (not shown) is then positioned and closed over the locking means 72 of the tube 34 and the locking means 54 of the valve seat 50. Lastly, the mold cavity is then injected and filled with plastic to complete the formation of the valve housing 70. Concurrently, the lower end 44 of the tube 34 and the upper end 53 of the valve seat 50 are overmolded by the valve housing 70.

For clarity of description, FIG. 4 shows valve housing 70 without the tube 34 and valve seat 50 which are integrally embedded when the valve housing 70 is formed. The valve housing 70 includes a passage 76 which hydraulically connects an outer surface 77 with an inner surface 78. The passage 76 is integrally created by a suitable mold insert (not shown) when the valve housing 70 is formed in the injection molding operation, thus eliminating the need for additional processing steps to form such a passage. The passage 76 is provided in order to allow fluid to be communicated from the fluid inlet port 14 to the valve seating surface 51 where the plunger 31 controls the flow of fluid.

Another feature integrally created when the valve housing 70 is formed is a sealing means 80 for sealing against the external sealing surface 22 (shown in FIG. 2) of the valve block 12. The sealing means 80 prevents fluid from leaking out of the receiving bore 13 to the atmosphere. In a preferred embodiment, the sealing means 80 takes the form of a flexible skirt 81. The skirt 81 extends downward from a valve locating surface 79, and is radially offset from a body 82 of the valve housing 70, wherein the body 82 connects the tube attachment end 71 and the valve seat attachment end 75. Furthermore, a sealing surface 83 of the skirt 81 is sized to be slightly larger in diameter than the working bore 19, while a chamfer 85 located at a free end 84 of the skirt 81 is slightly smaller in diameter than the working bore 19 to allow unhindered insertion of the valve 11 into the receiving bore 13. When the valve 11 is inserted into the receiving bore 13, the chamfer 85 will guide the skirt 81 into the working bore 19 before the sealing surface 83 of the skirt 81 engages the eternal sealing surface 22. When the sealing surface 83 of the skirt 81 does engage the external sealing surface 22, the flexible nature of the skirt 81 allows the skirt to be flexed inwardly toward the body 82. This flexing results in a reactive force being applied from the sealing surface 83 of the skirt 81 against the external sealing surface 22, thus providing a fluid tight seal. The sealing means 80 has herein been disclosed as the skirt 81, however, the sealing means 80 could take many forms such as an O-ring, lip seal, or flange seal.

Still another feature integrally created when the valve housing 70 is formed is the valve locating surface 79. The valve locating surface 79 is generally perpendicular to a central axis designated by the center line 86 of the valve housing 70. When the valve 11 is inserted fully into the receiving bore 13, the locating surface 79 comes into contact with the valve locating ledge 21 of the valve block 12 in order to axially position the valve 11 in the receiving bore 13. The formation of the valve locating surface 79 in the injection molding process eliminates the need for separate processes to form such a surface.

In operation, fluid enters the working bore 19 by way of the fluid inlet port 14. The passage 76 in the valve housing 70 allows fluid to pass from the working bore 19 to the valve seat 50. Here, the plunger 31 controls flow of the fluid through the central through bore 60 of the valve seat 50. Since this is a normally closed valve, the plunger 31 contacts the valve seating surface 51 when the actuation member 30 is not commanded to actuate. When the plunger 31 is in contact with the valve seating surface 51, fluid is not allowed to be communicated to the central through bore 60 of the valve seat 50. Additionally, fluid cannot escape to the atmosphere because of the sealing means 80 which seals against the external sealing surface 22, nor can fluid bypass the valve seat 50 to the fluid outlet port 15 because of the sealing means 58 which seals against the bypass sealing surface 23. When a controller (not shown) commands the valve to actuate, electrical current is supplied to the coil 36 which causes the armature 39 to overcome the force of the spring 40 and move axially upward. Because the plunger 31 is connected to the armature 39, the plunger 31 is lifted from the valve seating surface 51, thus allowing fluid to pass through the central through bore 60 and into the fluid outlet port 15.

We claim:

1. A valve for controlling the flow of fluid through a valve block, said valve block having a fluid inlet port, a fluid outlet port, and a receiving bore for receiving said valve, wherein said receiving bore hydraulically connects said fluid inlet and outlet ports, said receiving bore having a central axis, wherein said valve comprises:
a valve seat for placement between said fluid inlet and outlet ports, wherein said valve seat comprises a central axis which coincides with said central axis of said receiving bore, wherein said valve seat further comprises an upper end overmolded by a valve seat attachment end of a plastic valve housing; and
a tube comprising a central axis which coincides with said central axis of said receiving bore, wherein said tube further comprises a lower end overmolded by a tube attachment end of said valve housing.

2. The valve as in claim 1 wherein said valve seat further comprises a locking means for engaging said upper end of said valve seat with said valve seat attachment end of said valve housing.

3. The valve as in claim 2 wherein said locking means comprises an undercut in said valve seat.

4. The valve as in claim 1 wherein said tube further comprises a locking means for engaging said lower end of said tube with said tube attachment end of said valve housing.

5. The valve as in claim 4 wherein said locking means comprises a flange.

6. The valve as in claim 5 wherein said flange comprises one or more through holes.

7. The valve as in claim 1 wherein said valve housing comprises a passage hydraulically connecting an outer surface of said valve housing to an inner surface of said valve housing.

8. The valve as in claim 1 wherein said valve housing comprises a sealing means for sealing said valve housing against said valve block.

9. The valve as in claim 8 wherein said sealing means comprises a flexible skirt extending downward from a valve locating surface of said valve housing.

10. A valve and valve block assembly for controlling the flow of fluid, wherein said valve and valve block assembly comprises:
a valve block comprising a fluid inlet port, a fluid outlet port, and a receiving bore for receiving a valve, wherein said receiving bore hydraulically connects said fluid inlet and outlet ports, said receiving bore further comprising a central axis; and
a valve comprising:
a valve seat for placement between said fluid inlet and outlet ports, wherein said valve seat comprises a central axis which coincides with said central axis of said receiving bore, wherein said valve seat further comprises an upper end overmolded by a valve seat attachment end of a plastic valve housing; and
a tube comprising a central axis which coincides with said central axis of said receiving bore, wherein said tube further comprises a lower end overmolded by a tube attachment end of said valve housing.

11. The valve and valve block assembly as in claim 10 wherein said valve seat further comprises a locking means for engaging said upper end of said valve seat with said valve seat attachment end of said valve housing.

12. The valve and valve block assembly as in claim 11 wherein said locking means comprises an undercut in said valve seat.

13. The valve and valve block assembly as in claim 10 wherein said tube further comprises a locking means for engaging said lower end of said tube with said tube attachment end of said valve housing.

14. The valve and valve block assembly as in claim 13 wherein said locking means comprises a flange.

15. The valve and valve block assembly as in claim 14 wherein said flange comprises at least one through hole.

16. The valve and valve block assembly as in claim 10 wherein said valve housing comprises a passage hydraulically connecting an outer surface of said valve housing to an inner surface of said valve housing.

17. The valve and valve block assembly as in claim 10 wherein said valve housing comprises a sealing means for sealing said valve housing against said valve block.

18. A valve and valve block assembly as in claim 17 wherein said sealing means comprises a flexible skirt extending downward from a valve locating surface of said valve housing.
